(19) United States
(12) Patent Application Publication
(10) Pub. No.: US 2014/0140246 A1
(43) Pub. Date: May 22, 2014

(54) MONITORING OF CALL FORWARDING DESTINATION

(71) Applicants: Karthick Rajapandiyan, Chennai (IN); Muthusamy Muthiah, Chennai (IN)

(72) Inventors: Karthick Rajapandiyan, Chennai (IN); Muthusamy Muthiah, Chennai (IN)

(73) Assignee: ALCATEL LUCENT, Paris (FR)

(21) Appl. No.: 13/819,819

(22) PCT Filed: Jul. 5, 2011
(86) PCT No.: PCT/EP11/61273

§ 371 Date: May 13, 2013

(30) Foreign Application Priority Data
Aug. 31, 2010 (IN) 2527/CHE/2010

(51) Int. Cl. H04M 3/54; H04L 29/06

(52) U.S. Cl. CPC H04M 3/54; H04L 65/40
USPC 370/259

(57) ABSTRACT

Monitoring of the final Call Forwarding destination of a terminal that has activated the call forwarding feature. An application server, in an IMS network, checks if the user of the forwarded-to-terminal has activated the call forwarding feature and the application server sends a notification to the (originating) user, indicating that the user of the forwarded-to-terminal has activated the call forwarding feature. The originating user subscribes to the service of receiving the notification and the originating user receives the notification when the user of the forward- to-terminal has the call forwarding feature activated already or attempts to forward his call's at a later point of time. Feature is known as communication diversion notification (CDIVN).

### TECHNICAL FIELD

The present invention relates to communication networks and, more particularly, to call forwarding in communication networks.

### BACKGROUND

Call forwarding is a feature in communication networks that allows a call request to be redirected to a forward-to-number. That is, a call request made by a calling user to the called user is redirected to a third number and the call request would then be received at the third number. The third number may belong to the called user or to a third user. For example, the called user may enable call forwarding feature as the called user prefers to answer all his calls from his own forwarded-to-number or if the called user wishes to have the forwarded to user answer all his calls on his behalf. Thus, call forwarding gives a user greater flexibility in answering call requests by allowing the user to answer the call request from a convenient forward-to-number. Here the forward-to-number may a number or an address. For example, the forward-to-number may be a Session Initiation Protocol (SIP) address as user1@example1.com and any call requests received by the called user would be redirected to the SIP address user1@example1.com.

However, it may happen that the forward-to-number has also used call forwarding feature. In this situation when the call request is redirected to the forward-to-number, the call request would again be redirected to a second forward-to-number. For example, if user A calls user B, and user B has call forwarding activated, then the call request from user A would be redirected to, say, user C. Now if user C also has call forwarding activated, then the call request would then be redirected, a second time to say, user D. Here user B wishes all calls to be answered by user C but the call request is being sent to user D. Eventually, the called user would not be able to answer the call from the preferred forward-to-number. Also, the called user is not aware that the call request is being redirected a second time.

### SUMMARY

In view of the foregoing, an embodiment herein provides a method for notifying a user of call forwarding feature activated by a forward-to-number in an Internet Protocol Multimedia Subsystem (IMS) Network. An application server, in the IMS network, checks if the forward-to-number has activated the call forwarding feature and the application server sends a notification to the user indicating the user of the activation of the call forwarding feature by the forward-to-number. The user subscribes for the service of receiving the notification and the user receives the notification when the user actives the call forwarding feature and the forward-to-number has already call forwarding feature activated. The user of the feature also receives the notification when the forward-to-number attempts to activate call forwarding feature. The user receives the notification in at least one of text message and audio message. The forward-to-number is at least one of Session Initiation Protocol (SIP) address, Public Switched Telephone Network (PSTN) number and Cell phone number. The user is in the IMS network having the application server or the user is in a different IMS network

Embodiments further disclose an application server, in an Internet Protocol Multimedia Subsystem (IMS) Network, for notifying a user of call forwarding feature activated by a forward-to-number in the Internet Protocol Multimedia Subsystem (IMS) Network. The application server checks if the forward-to-number has activated the call forwarding feature and sends a notification to the user indicating the user of the activation of the call forwarding feature by the forward-to-number. The application server enables the user to subscribe to service of receiving the notification. The application server sends the notification to the user in at least one of text message and audio message. The application server sends the notification to the user when the user activates the call forwarding feature and the forward-to-number has the call forwarding feature activated. The application server is sends the notification to the user when the forward-to-number activates the call forwarding feature.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a block diagram of users in an IMS network, according to an embodiment herein;

FIG. 2 illustrates a block diagram of an Application Server, according to an embodiment herein;

FIGS. 3a and 3b are flowcharts depicting a method for notifying a user of call forwarding feature activated by a forward-to-number, according to an embodiment herein;

FIG. 4 illustrates a flow diagram of an example illustrating a user being notified of call forwarding feature activated by the forward-to-number immediately when the user activates call forwarding feature, according to an embodiment herein; and

FIG. 5 illustrates a flow diagram of an example illustrating a user being notified of call forwarding feature activated by a forward-to-number at a later point in time, according to an embodiment herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

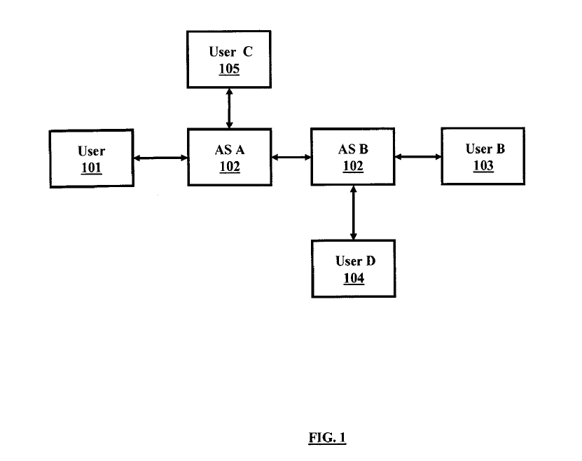

The embodiments herein disclose a system and method for notifying a user of call forwarding feature activated by a forward-to-number. Referring now to the drawings, and more particularly to FIGS. 1 through 5, where similar reference characters denote corresponding features consistently throughout the figures, there are shown embodiments.

FIG. 1 illustrates a block diagram of users in IMS networks. Users of a communication network may activate call forwarding feature in order to redirect an incoming call request to a forward-to-number. For example, user B 103 may have all incoming call requests redirected to user C 105 or user D 104. The forward-to-number is the number to which the original call request would be forwarded to. When a user 101 wishes to activate call forwarding, the user 101 sends the service code to activate the feature. The forward-to-number may be in the same IMS network of user 101 or in a different IMS network. Once call forwarding feature is activated, future call requests to user 101 would be received at the forward-to-number.

Call forwarding feature can be activated by any user in the network. The feature can also be activated by the forward-to-number. For example, if user 101 has forwarded all calls to user B 103, then user B 103 can use call forwarding feature and forward all the calls to user D 104 or to user C 105. When the forward-to-number activates call forwarding a notification is sent to user 101 indicating to the user 101 about the activation of call forwarding feature by the forward-to-number. The notification is sent to the user 101 by an application server (AS) 102, where the application server 102 belongs to the network of the forward-to-number. If the user 101 and the forward-to-number are in different networks, then the user 101 would be connected to one application server 102 and the forward-to-number would be connected to a different application server 102. If the user 101 and the forward-to-number are in the same IMS network, then the user 101 and the forward-to-number would be connected to the same application server 102. After receiving the notification and determining that the forward-to-number also has activated call forwarding, the user 101 can choose to act based on the notification. For example, the user 101 can choose to continue forwarding calls to the same forward-to-number or the user 101 may decide to stop forwarding calls to the forward-to-number and have future call forwarded to a new forward-to-number.

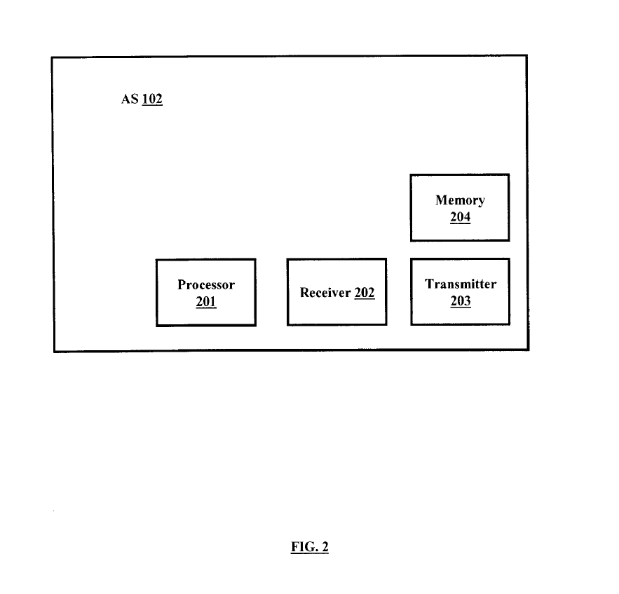

FIG. 2 illustrates a block diagram of an Application Server. When a user 101 wishes to activate call forwarding, the user 101 sends the service code to activate the feature. The forward-to-number may be in the same IMS network of user 101 or in a different IMS network. Once call forwarding feature is activated, future call requests to user 101 would be received at the forward-to-number. To activate call forwarding feature, the user 101 sends a service code to the application server 102 in the network of user 101. The user 101 may also send the forward-to-number to the application server 102. For example, the forward-to-number may be a SIP address as userB@example1.com or a telephone number as +91-9876543210. On receiving the service code the application server 102 determines that the user 101 wishes to activate call forwarding feature. The application server 102 receives the service code through a receiver 202. The application server 102 obtains the forward-to-number from the service code message and updates the user 101 profile stored in a memory 204. The application server 102 determines that incoming call requests to the user 101 have to be forwarded to the forward-to-number stored in the memory 204. A processor 201 controls the functioning of the application server 102. The processor 201 co-ordinates all the operations performed by the application server 102. The processor 201 updates the user 101 profile in the memory 204. The processor 201 also checks if the user 101 has subscribed to the service of receiving notification of call forwarding attempts or activation being made by the forward-to-number. If the user 101 has subscribed to the service, then the processor 201 does a third party subscription for the forward-to-number and sends a subscription message to the forward-to-number. For example, if user 101 wishes to have user B 103 as the forward-to-number and user B 103 activates call forwarding, then the application server 102 in the network of user 101 does a third party subscription for user B 103 and sends the subscription message to the application server 102 in the network of user B 103. The application server 102 sends messages using a transmitter 203.

When the application server 102 receives the subscription message, the application server 102 determines that the user 101 has subscribed to the service of receiving notifications. The processor 201 enables a notification parameter and updates the user B 103 profile by adding information about the user 101 in the profile of user B 103. The profile of user B would be stored in the memory 204. For example, the processor 201 may include the contact number of the user 101 in the profile of user B 103.

Now, user B 103 may decide to activate call forwarding feature or user B 103 may already have call forwarding feature activated. In this scenario, the user 101 would not have call requests being answered by the user B 103 since user B 103 has also activated call forwarding. When the application server 102 in the network of user B 103 determines that user B wishes to activate call forwarding or already has call forwarding activated, the processor 201 checks the profile of user B 103 to determine if the user 101 has to be notified about the activation of call forwarding feature by user B 103. The processor 201 may check to determine if the notification parameter has been set for the user 101 in the profile of user B 103. If the processor determines that the user 101 must be notified of the activation of call forwarding by user B 103, then the processor sends a notification to the user 101. The processor 201 sends the notification through the transmitter 203. The notification indicates to the user 101 that user B has activated or attempts to activate call forwarding feature. The notification may be sent to the user 101 immediately when the user 101 sends the service code to activate call forwarding or the notification may be sent at a later point in time after the forwarded-to-number attempts to activate call forwarding feature That is, if user B already has call forwarding activated when the user 101 sends the service code, then the application server sends the notification immediately to the user 101. If the forwarded-to-number does not have call forwarding activated when the user 101 sends the service code and at a later point in time user B 103 activates call forwarding, then the notification is sent at the instant of time when the user B activates call forwarding. For example, if the user 101 has activated call forwarding with the forward-to-number being user B 103 and user B 103 does not have call forwarding activated, and then no notification is sent to the user 101. If after some days, say after 3 days, user B 103 activates call forwarding, then the notification is sent to the user 101 3 days after the user 101 sends the service code. The application sever 102 may send the notification to a media server and the media server may convey the notification to the user 101 as a text message or an audio message. After receiving the notification and determining that the forward-to-number also has activated call forwarding, the user 101 can choose to act based on the notification.

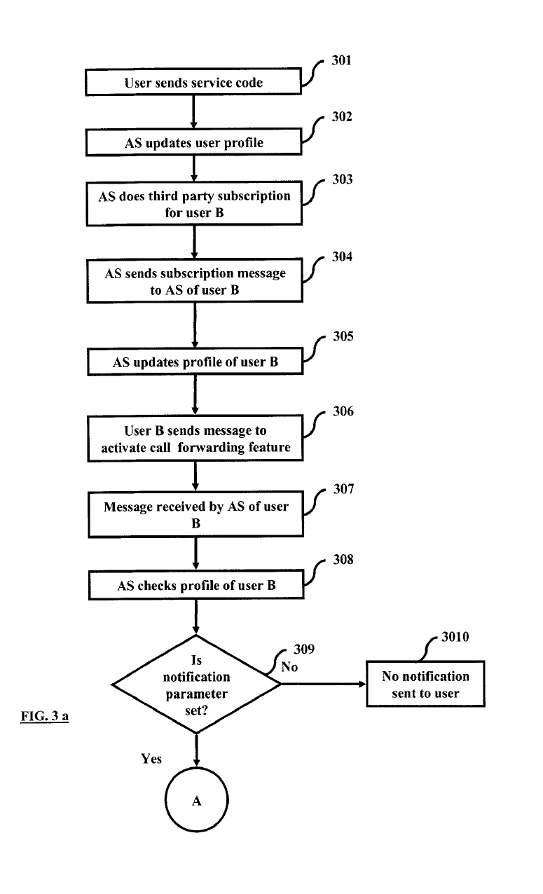

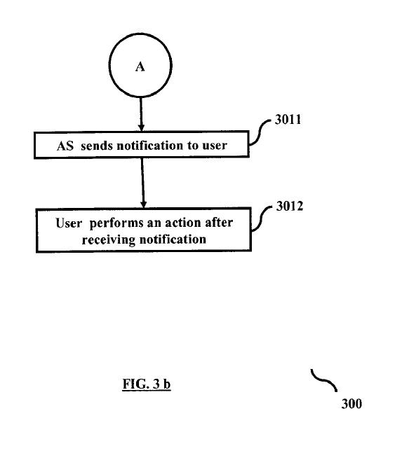

FIGS. 3a and 3b are flowcharts depicting a method for notifying a user of call forwarding feature activated by a forward-to-number. When a user 101 wishes to activate call forwarding, the user 101 sends (301) the service code to activate the feature. The forward-to-number may be in the same IMS network of user 101 or in a different IMS network. Once call forwarding feature is activated, future call requests to user 101 would be received at the forward-to-number. To activate call forwarding feature, the user 101 sends a service code to the application server 102 in the network of user 101. The user 101 may also send the forward-to-number to the application server 102. On receiving the service code the application server 102 determines that the user 101 wishes to activate call forwarding feature. The application server 102 obtains the forward-to-number from the service code message and updates (302) the user 101 profile. The application server 102 determines that incoming call requests to the user 101 have to be forwarded to the forward-to-number. If the user 101 has subscribed to the service of receiving notification of call forwarding attempts or activation being made by the forward-to-number, then the application server 102 does a third party subscription (303) for the forward-to-number and sends a subscription message to the forward-to-number. If the forward-to-number is the number of user B 103, then the application server 102 does a third party subscription (303) for user B 103. The application server 102 of the user 101 sends (304) a subscription message to the application server of user B 103.

When the application server 102 of user B 103 receives the subscription message, the application server 102 determines that the user 101 has subscribed to the service of receiving notifications. The application server 102 of user B 103 enables the notification parameter and updates (305) the user B 103 profile by adding information about the user 101 in the profile of user B 103.

User B 103 may decide to activate call forwarding feature or user B 103 may already have call forwarding feature activated. When user B 103 decides to activate call forwarding, user B 103 sends (306) a message to the application server 102 of user B 103 in order to activate call forwarding feature. When the application server 102 in the network of user B 103 receives (307) the message and determines that user B wishes to activate call forwarding or if user B 103 already has call forwarding activated, the application server 102 checks (308) the profile of user B 103 to determine if the user 101 has to be notified about the activation of call forwarding feature by user B 103. If the notification parameter is not set (309), then no notification is sent (3010) to the user 101. If the notification parameter is set, then the application server 102 of user B 103 sends a notification to the user 101. The notification indicates to the user 101 that user B has activated or attempts to activate call forwarding feature. The notification may be sent to the user 101 immediately when the user 101 sends the service code to activate call forwarding or the notification may be sent at a later point in time after the user sends the service code. The application sever 102 may send the notification to a media server and the media server may convey the notification to the user 101. After receiving the notification and determining that the forward-to-number also has activated call forwarding, the user 101 can choose to act based on the notification. The various actions in method 300 may be performed in the order presented, in a different order or simultaneously. Further, in some embodiments, some actions listed in FIGS. 3a and 3b may be omitted.

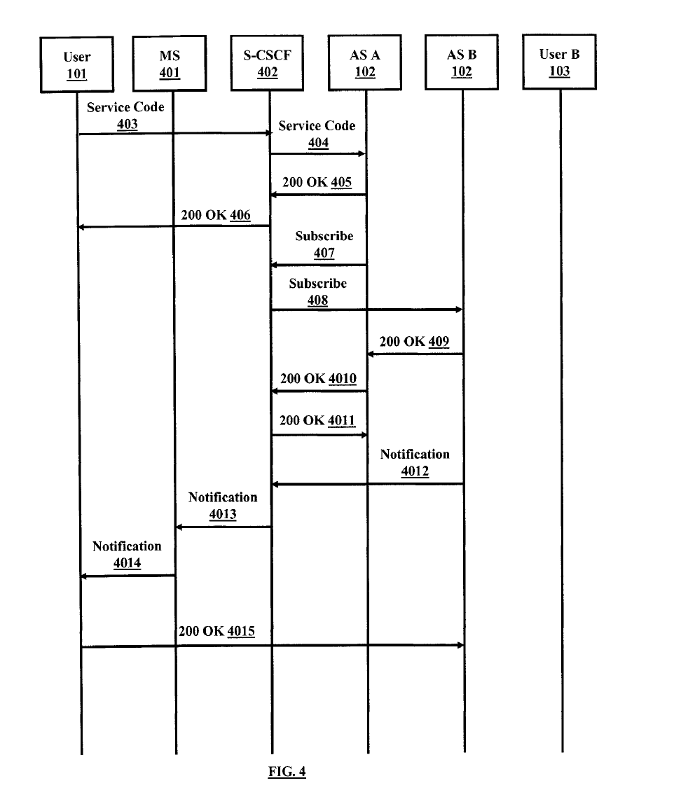

FIG. 4 illustrates a flow diagram of an example illustrating a user being notified of call forwarding feature activated by the forward-to-number immediately when the user activates call forwarding feature. When a user 101 wishes to activate call forwarding, the user 101 sends the service code to activate the feature. The forward-to-number may be in the same IMS network of user 101 or in a different IMS network. Once call forwarding feature is activated, future call requests to user 101 would be received at the forward-to-number. To activate call forwarding feature, the user 101 sends a service code to the application server 102 in the network of user 101. The user 101 may also send the forward-to-number to the application server 102. The service code sent by the user 101 is indicated as a Service Code 403 message and the service code 403 would be received by the S-CSCF 402. The S-CSCF 402 relays the service code to the application server 102 (AS A) in the network of the user 101. The message sent by the S-CSCF 402 to the AS A 102 may be the Service Code 404 message.

On receiving the service code successfully, the AS A 102 acknowledges the receipt of the service code by sending an acknowledgement to the user 101 through the S-CSCF 402. The acknowledgement sent by the AS A 102 to the S-CSCF 402 may be the 200 OK 405 message and the acknowledgement sent by the S-CSCF 402 to the user 101 may be the 200 OK 406 message. On receiving the service code the application server 102 also determines that the user 101 wishes to activate call forwarding notification feature. The application server 102 obtains the forward-to-number from the service code message and updates the user 101 profile. The application server 102 determines that incoming call requests to the user 101 have to be forwarded to the forward-to-number. If the user 101 has subscribed to the service of receiving notification of call forwarding attempts or activation being made by the forward-to-number, then the application server 102 does a third party subscription for the forward-to-number and sends a subscription message to the forward-to-number. If the forward-to-number is the number of user B 103, then the application server 102 does a third party subscription for user B 103. The application server 102 of the user 101 sends, AS A 102, a subscription message to the application server of user B 103, AS B 102. The AS A 102 sends the subscription message to the AS B 102 through the S-CSCF 402. The subscription message sent by the AS A 102 to the S-CSCF 402 may be the Subscribe 407 message and the subscription message sent by the S-CSCF 402 to the AS B 102 may be the Subscribe 408 message.

On receiving the subscription message successfully, the AS B 102 acknowledges the receipt of the subscription message by sending an acknowledgement to AS A 102. The acknowledgement sent by AS B 102 to AS A 102 may be the 200 OK 409 message and the acknowledgement sent by the AS A 102 to the S-CSCF 402 may be the 200 OK 4010 message and the acknowledgement sent by the S-CSCF 402 to the AS A 102 may be the 200 OK 4011 message. When AS B 102 receives the subscription message, the AS B 102 determines that the user 101 has subscribed to the service of receiving notifications. The AS B 102 of user B 103 enables the notification parameter and updates the user B 103 profile by adding information about the user 101 in the profile of user B 103.

If user B already has call forwarding activated, then the AS B 102 checks the profile of user B 103 to determine if the user 101 has to be notified about the activation of call forwarding feature by user B 103. If the notification parameter is set, then the AS B 102 sends a notification to the user 101. The notification indicates to the user 101 that user B has activated call forwarding feature. The AS B 102 may send the notification to the media server, MS 401, and the MS 401 may convey the notification to the user 101. The notification message sent by the AS B 102 to the S-CSCF 402 may be the Notification 4012 message, the notification sent by the S-CSCF 402 to the MS 401 may be the Notification 4013 message and the notification sent by the MS 401 to the user 101 may be the Notification 4014 message. After receiving the notification and determining that the forward-to-number also has activated call forwarding, the user 101 can choose to act based on the notification. The user 101 may then acknowledge the reception of the notification message by sending an acknowledgement, 200 OK 4015 message to the AS B 102.

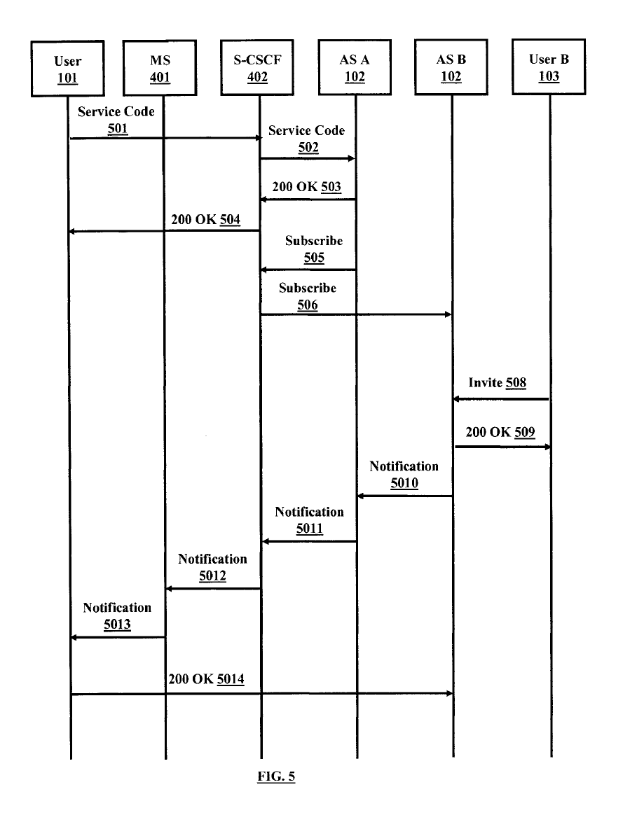

FIG. 5 illustrates a flow diagram of an example illustrating a user being notified of call forwarding feature activated by a forward-to-number at a later point in time. When a user 101 wishes to activate call forwarding, the user 101 sends the service code to activate the feature. The forward-to-number may be in the same IMS network of user 101 or in a different IMS network. Once call forwarding feature is activated, future call requests to user 101 would be received at the forward-to-number. To activate call forwarding feature, the user 101 sends a service code to the application server 102 in the network of user 101. The user 101 may also send the forward-to-number to the application server 102. The service code sent by the user 101 is indicated as a Service Code 501 message and the service code 501 would be received by the S-CSCF 402. The S-CSCF 402 relays the service code to the application server 102 (AS A) in the network of the user 101. The message sent by the S-CSCF 402 to the AS A 102 may be the Service Code 502 message.

On receiving the service code successfully, the AS A 102 acknowledges the receipt of the service code by sending an acknowledgement to the user 101 through the S-CSCF 402. The acknowledgement sent by the AS A 102 to the S-CSCF 402 may be the 200 OK 503 message and the acknowledgement sent by the S-CSCF 402 to the user 101 may be the 200 OK 504 message. On receiving the service code the application server 102 also determines that the user 101 wishes to activate call forwarding feature. The application server 102 obtains the forward-to-number from the service code message and updates the user 101 profile. The application server 102 determines that incoming call requests to the user 101 have to be forwarded to the forward-to-number. If the user 101 has subscribed to the service of receiving notification of call forwarding attempts or activation being made by the forward-to-number, then the application server 102 does a third party subscription for the forward-to-number and sends a subscription message to the forward-to-number. If the forward-to-number is the number of user B 103, then the application server 102 does a third party subscription for user B 103. The application server 102 of the user 101 sends, AS A 102, a subscription message to the application server of user B 103, AS B 102. The AS A 102 sends the subscription message to the AS B 102 through the S-CSCF 402. The subscription message sent by the AS A 102 to the S-CSCF 402 may be the Subscribe 505 message and the subscription message sent by the S-CSCF 402 to the AS B 102 may be the Subscribe 506 message.

When AS B 102 receives the subscription message, the AS B 102 determines that the user 101 has subscribed to the service of receiving notifications. The AS B 102 of user B 103 enables the notification parameter and updates the user B 103 profile by adding information about the user 101 in the profile of user B 103.

If, at a later point in time, say 7 days, user B 103, the forwarded-to-number, wishes to activate call forwarding, then user B 103 may send the service code to AS B 102 to activate call forwarding. The service code may also be sent in an invitation message, Invite 508 message. The AS B 102 acknowledges the successful reception of the invitation message by sending an acknowledgement to the user B 103. The acknowledgement message sent by the AS B 102 to the user B 103 may be a 200 OK 509 message. On receiving the service code from user B 103 to activate call forwarding, the AS B 102 checks the profile of user B 103 to determine if the user 101 and any other user who have to be notified about the activation of call forwarding feature by user B 103. If the notification parameter is set, then the AS B 102 sends a notification to the user 101 and to all the other users present in the notification list of the profile of the forwarded-to-number, user B 103. The notification indicates to the user 101 that user B has activated call forwarding feature. The AS B 102 may send the notification to the user 101 through the AS A 102, S-CSCF 402 and the MS 401. The notification message sent by the AS B 102 to the AS A 102 may be the Notification 5010 message, the notification message sent by the AS A 102 to the S-CSCF 402 may be the Notification 5011 message, the notification message sent by the S-CSCF 402 to the MS 401 may be the Notification 5012 message and the notification message sent by the MS 401 to the user 101 may be the Notification 5013 message. After receiving the notification and determining that the forward-to-number also has activated call forwarding, the user 101 can choose to act based on the notification. The user 101 may then acknowledge the reception of the notification message by sending an acknowledgement, 200 OK 5014 message to the AS B 102.

The embodiments disclosed herein can be implemented through at least one software program running on at least one hardware device and performing network management functions to control the network elements. The network elements shown in FIG. 1 and FIG. 2 include blocks which can be at least one of a hardware device, or a combination of hardware device and software module.

The embodiment disclosed herein specifies a system and method for notifying a user of call forwarding feature activated by the forward-to-number. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a code written in e.g. Very high speed integrated circuit Hardware Description Language (VHDL) or any other coding language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented in pure hardware or partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

1. A method for notifying a user of call forwarding feature activated by a forward-to-number in an Internet Protocol Multimedia Subsystem Network, said network comprising an application server said method comprising:
said application server checking if said forward-to-number has activated call forwarding feature; and
said application server sending a notification to said user indicating said user of activation of call forwarding feature by said forward-to-number.

2. The method, as claimed in claim 1, wherein said user subscribes for service of receiving said notification.

3. The method, as claimed in claim 1, wherein said user receives said notification when said user activates said call forwarding feature and said forward-to-number has call forwarding feature activated.

4. The method, as claimed in claim 1, wherein said user receives said notification when said forward-to-number activates call forwarding feature.

5. The method, as claimed in claim 1, wherein said user receives said notification in at least one of:
text message; and
audio message.

6. The method, as claimed in claim 1, wherein said forward-to-number is at least one of:
Session Initiation Protocol address;
Public Switched Telephone Network number; and
Cell phone number.

7. The method, as claimed in claim 1, wherein said user is in said Internet Protocol Multimedia Subsystem Network.

8. The method, as claimed in claim 1, wherein said user is in a different Internet Protocol Multimedia Subsystem Network.

9. An application server, in an Internet Protocol Multimedia Subsystem Network, for notifying a user of call forwarding feature activated by a forward-to-number in said Internet Protocol Multimedia Subsystem Network, said application server having at least one means adapted for:
checking if said forward-to-number has activated call forwarding feature; and
sending a notification to said user indicating said user of said activation of call forwarding feature by said forward-to-number.

10. The application server, as claimed in claim 9, wherein said application server is adapted to enable said user to subscribe to service of receiving said notification.

11. The application server, as claimed in claim 9, wherein said application server is adapted to send said notification to said user in at least one of:
text message; and
audio message.

12. The application server, as claimed in claim 9, wherein said application server is adapted to send said notification to said user when said user activates call forwarding feature and said forward-to-number has call forwarding feature activated.

13. The application server, as claimed in claim 9, wherein said application server is adapted to send said notification to said user when said forward-to-number activates call forwarding feature.
